(19) United States
(12) Patent Application Publication
(10) Pub. No.: US 2025/0170828 A1
(43) Pub. Date: May 29, 2025

(54) INKJET HEAD AND METHOD OF MANUFACTURING THE SAME

(71) Applicant: Samsung Display Co., LTD., Yongin-si (KR)

(72) Inventors: JAESIK KIM, Yongin-si (KR); JUNGHAN SEO, Yongin-si (KR); WOO YONG SUNG, Yongin-si (KR); KWANHYUCK YOON, Yongin-si (KR); SEUNGHO YOON, Yongin-si (KR); BYEONGJUN LEE, Yongin-si (KR); HYEMIN LEE, Yongin-si (KR); SEUNGGUN CHAE, Yongin-si (KR)

(21) Appl. No.: 18/932,981

(22) Filed: Oct. 31, 2024

(30) Foreign Application Priority Data
Nov. 24, 2023 (KR) 10-2023-0165521

(51) Int. Cl. B41J 2/16; B41J 2/14

(52) U.S. Cl. CPC B41J 2/162; B41J 2/14201; B41J 2/1433; B41J 2/1623; B41J 2/1634; B41J 2/164; B41J 2202/22

(57) ABSTRACT

An inkjet head includes a nozzle which ejects ink, a nozzle plate adjacent to the nozzle and defining the nozzle, a protective layer disposed under the nozzle plate, a first coating layer disposed on a side surface of the nozzle plate and a side surface of the protective layer, and a liquid-repellent layer disposed on a rear surface of the first coating layer and a side surface of the first coating layer, and the first coating layer covers a step defined between the nozzle plate and the protective layer.

This application claims priority to Korean Patent Application No. 10-2023-0165521, filed on Nov. 24, 2023, and all the benefits accruing therefrom under 35 U.S.C. § 119, the content of which in its entirety is herein incorporated by reference.

### BACKGROUND

### 1. Field

Embodiments relate to an inkjet head. More particularly, the embodiments relate to the inkjet head and a method of the manufacturing the same.

### 2. Description of the Related Art

The display device is a device that displays an image for providing visual information to a user. Types of display devices include liquid crystal displays, light-emitting diode displays, organic light-emitting inkjet heads, and quantum dot displays.

The display device may be manufactured using an ink ejected from an inkjet apparatus. The inkjet apparatus may include an inkjet head that ejects the ink. The inkjet head may be coated with a plurality of coating layers to improve an ejection precision and protect a nozzle of the inkjet head.

### SUMMARY

Embodiments provide an inkjet head with improved abrasion resistance.

Embodiments provide a method of manufacturing the inkjet head.

An inkjet head in an embodiment may include a nozzle which ejects ink, a nozzle plate adjacent to the nozzle, defining the nozzle and including a side surface, a protective layer disposed under the nozzle plate and including a side surface, a first coating layer disposed on the side surface of the nozzle plate and the side surface of the protective layer and including a rear surface and a side surface, and a liquid-repellent layer disposed on the rear surface of the first coating layer and the side surface of the first coating layer. The first coating layer may cover a step defined between the nozzle plate and the protective layer.

In an embodiment, the inkjet head may further include a piezoelectric plate disposed on the nozzle plate, and the first coating layer may extend from a lower portion of the protective layer to a height where an upper surface of the piezoelectric plate is disposed.

In an embodiment, the inkjet head may further include a second coating layer disposed between the first coating layer and the liquid-repellent layer, and contacting the liquid-repellent layer.

In an embodiment, the nozzle plate may include an inclined portion having an inclined surface inclined in a direction away from the nozzle, and the second coating layer may extend from a lower portion of the first coating layer to a height where the side surface of the nozzle plate disposed under the inclined portion is disposed.

In an embodiment, the second coating layer may extend from the lower portion of the protective layer to a height where the upper surface of the piezoelectric plate is disposed.

In an embodiment, the inkjet head may further include a third coating layer covering at least a portion of side surface of the second coating layer.

In an embodiment, a thickness of the third coating layer along a thickness direction perpendicular to a main plane extension direction of the third coating layer may be substantially equal to a thickness of the liquid-repellent layer along the thickness direction.

In an embodiment, the inkjet head may further include a metal plate disposed on the piezoelectric plate, and a metal mesh disposed on the metal plate. The third coating layer MAY cover each of the metal plate and the metal mesh.

In an embodiment, the liquid-repellent layer may contact a rear surface of the second coating layer.

In an embodiment, the first coating layer may include an organic material, an inorganic material, and a metal material.

In an embodiment, the second coating layer may include an inorganic material.

In an embodiment, the second coating layer may include a polymer compound

In an embodiment, the liquid-repellent layer may include a hydrophobic material, and the hydrophobic material may have a water contact angle which is about 100 degrees or more and about 200 degrees or less.

In an embodiment, a thickness of the first coating layer along a thickness direction perpendicular to a main plane extension direction of the first coating layer may be about 500 nanometers (nm) or less, and a thickness of the second coating layer along the thickness direction may be about 1000 nm or less.

In an embodiment, a thickness of the liquid-repellent layer along a thickness direction perpendicular to a main plane extension direction of the liquid-repellent layer may be about 20 nm or less.

In an embodiment, the liquid-repellent layer contacts the rear surface of the first coating layer.

A method of manufacturing an inkjet head in an embodiment may include forming a preliminary protective layer on a substrate, forming a nozzle plate by irradiating an intense light on the substrate, forming a protective layer having a step with the nozzle plate together by irradiating the intense light on the preliminary protective layer, forming a piezoelectric plate on the nozzle plate, forming a first coating layer covering each of a rear surface of the nozzle plate, a side surface of the nozzle plate, a rear surface of the piezoelectric plate, a side surface of the piezoelectric plate, and the protective layer, and forming a liquid-repellent layer, overlapping at least a portion of the first coating layer, under the first coating layer.

In an embodiment, the forming the protective layer may include forming a first protective layer from a first preliminary protective layer contacting the rear surface of the nozzle plate, forming a second protective layer from a second preliminary protective layer disposed under the first preliminary protective layer, and forming a third protective layer from a third preliminary protective layer disposed under the second preliminary protective layer.

In an embodiment, the forming the third protective layer may include modifying a surface of the third preliminary protective layer and removing at least a portion of a fluorine (F) included in the surface of the third preliminary protective layer.

In an embodiment, the method may further include forming a second coating layer on the first coating layer and forming the liquid-repellent layer on a rear surface of the second coating layer

An inkjet head in embodiments of the disclosure may include a nozzle plate, a piezoelectric plate, a protective layer defining a step with the nozzle plate, and a coating layer covering a rear surface of the nozzle plate, a side surface of the nozzle plate, a side surface of the piezoelectric plate, and a rear surface of the protective layer. The step may be compensated by sequentially covering the nozzle plate and the protective layer disposed at the step with a composite coating layer, an inorganic coating layer, and a liquid-repellent coating layer included in the coating layer. Accordingly, when a scratch is generated in the protective layer covering the rear surface of the nozzle plate, a frictional force may be prevented from being concentrated on a portion of the rear surface of the nozzle plate which is exposed. Therefore, a deterioration in ink ejection characteristics of the inkjet head may be reduced and a durability of the inkjet head may be improved.

In addition, an adhesive coating layer including a polymer compound may be disposed between the composite coating layer and the liquid-repellent layer. The adhesive coating layer may improve a bonding force between the composite coating layer and the adhesive coating layer and may serve as a buffer. Accordingly, a density of the liquid-repellent coating layer may increase, thereby a durability of the inkjet head may further increase.

In a method of manufacturing the inkjet head in embodiments of the disclosure may reduce an amount of fluorine on a rear surface of the third protective by performing a surface modification process on the rear surface of the third protective layer included in the protective layer. Accordingly, an adhesion with the composite coating layer or the inorganic coating layer attached to the rear surface of the third protective layer may be increased.

### BRIEF DESCRIPTION OF THE DRAWINGS

Illustrative, non-limiting embodiments will be more clearly understood from the following detailed description in conjunction with the accompanying drawings.

FIG. 1 is a perspective view illustrating an embodiment of a inkjet apparatus.

FIG. 2 is a perspective view illustrating a head module included in the inkjet apparatus of FIG. 1.

FIG. 3 is a perspective view illustrating an inkjet head included in the head module of FIG. 2.

FIG. 4 is a cross-sectional view illustrating an embodiment of cross-section taken along line I-I′ of FIG. 3.

FIGS. 5, 6, 7, 8, 9, 10, and 11 are cross-sectional views illustrating a method of manufacturing the inkjet head of FIG. 3.

FIG. 12 is a cross-sectional view illustrating another embodiment of cross-section taken along line I-I′ of FIG. 3.

FIG. 13 is a cross-sectional view illustrating another embodiment of cross-section taken along line I-I′ of FIG. 3.

FIG. 14 is a cross-sectional view illustrating another embodiment of cross-section taken along line I-I′ of FIG. 3.

FIG. 15 is a cross-sectional view illustrating another embodiment of cross-section taken along line I-I′ of FIG. 3.

FIG. 16 is a cross-sectional view illustrating another embodiment of cross-section taken along line I-I′ of FIG. 3.

FIG. 17 is a cross-sectional view illustrating another embodiment of cross-section taken along line I-I′ of FIG. 3.

### DETAILED DESCRIPTION

Hereinafter, display devices in embodiments will be described in more detail with

reference to the accompanying drawings. The same reference numerals are used for the same components in the drawings, and redundant descriptions of the same components will be omitted.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within ±30%, 20%, 10%, 5% of the stated value, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

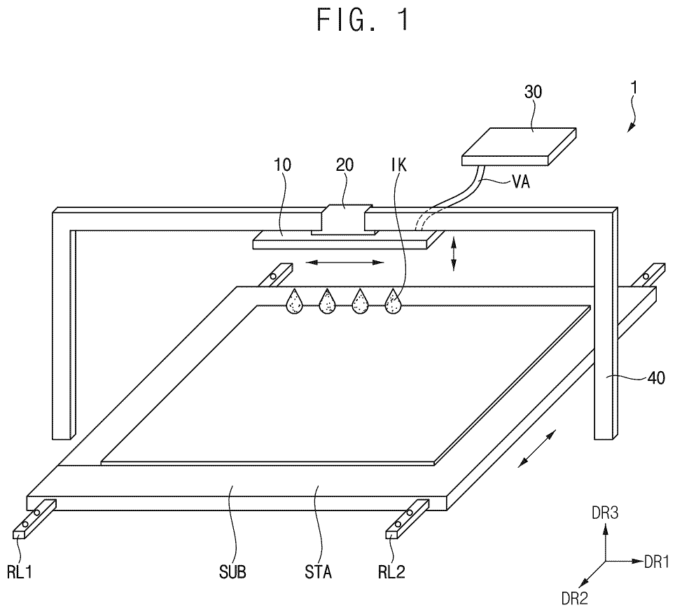

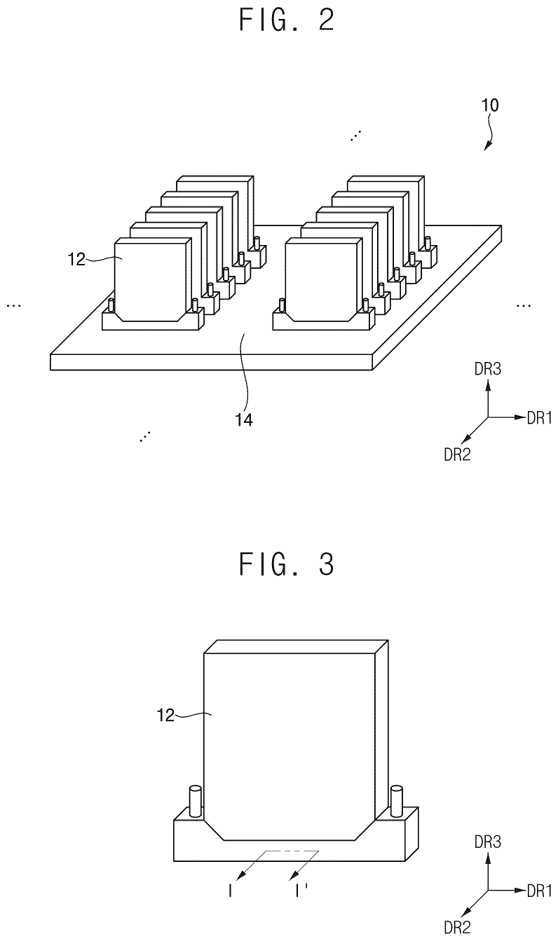

FIG. 1 is a perspective view illustrating an embodiment of a inkjet apparatus. FIG. 2 is a perspective view illustrating a head module included in the inkjet apparatus in FIG. 1. FIG. 3 is a perspective view illustrating an inkjet head included in the head module in FIG. 2.

In this specification, a plane may be defined by a first direction DR1 and a second direction DR2. In an embodiment, the second direction DR2 may be perpendicular to the first direction DR1. In addition, the third direction DR3 may be perpendicular to the plane.

Referring to FIG. 1, an inkjet apparatus 1 in an embodiment of the disclosure may include a head module 10, a stage STA, a moving part 20, a control part 30, and a support part 40.

The head module 10 may eject an ink IK from the inkjet apparatus 1. In an embodiment, the head module 10 may eject the ink IK onto a base substrate SUB disposed on the stage STA, for example. As the ink IK is ejected, a display device may be manufactured. In an embodiment, the display device may be a device that emits light and generates images, for example.

The base substrate SUB may be disposed on the stage STA. The stage STA may be moved in the second direction DR2 by a first guide rail RL1 and a second guide rail RL2. That is, the base substrate SUB may be moved in the second direction along the first and second guide rail RL1 and RL2. Accordingly, the ink IK ejected from the head module 10 may be applied to a predetermined location on the base substrate SUB.

The moving part may be combined with the head module 10. In an embodiment, the moving part 20 may move the head module 10 combined with the moving part 20 in the first direction DR1 and the third direction DR3, for example. As the head module 10 moves in the first and third direction DR1 and DR3 through the moving part 20, a location where the ink IK is ejected may be specified.

The control part 30 may be electrically connected to the head module 10. The control part 30 may include an ink supply module and an ink control module. Specifically, the ink supply module included in the control part 30 may supply the ink IK to the head module through a valve VA. In addition, the ink control module may apply an electrical signal to the head module 10. According to the electrical signal, the control part 30 may control a time and a location for ejecting the ink IK on the base substrate SUB.

The support part 40 may fix the head module 10 and the moving part 20 to be disposed at an upper portion of the stage STA. The moving part 20 may move along a portion of the support part 40 in the first direction DR1. Accordingly, the head module 10 combined with the moving part 20 may be moved in the first direction DR1 and in a direction opposite to the first direction DR1.

Referring to FIGS. 2 and 3, the head module 10 may include the inkjet head 12 and the head plate 14. The inkjet head 12 may be one of components included in the inkjet apparatus 1. In an embodiment, the inkjet head 12 may be one of components included in the head module 10 of the inkjet apparatus 1, for example. The inkjet apparatus 1 may be a apparatus that applies ink IK to a base substrate SUB, which is a printing object. The inkjet head 12 may be a part of the inkjet apparatus 1 that ejects ink IK.

The head plate 14 may be disposed under the inkjet head 12. In an embodiment, the head plate 14 may support the inkjet head 12 at a lower portion of the inkjet head 12, for example. A plurality of inkjet heads 12 may be disposed on the head plate 14.

The inkjet head 12 may be disposed on the head plate 14 in the first direction DR1 and the second direction DR2. The plurality of inkjet heads 12 may form a head pack. In an embodiment, one head pack may be formed by combining five inkjet heads 12 adjacent to each other in the second direction DR2 as one set, for example. However, a number of inkjet heads 12 forming one head pack may not be limited to this, and at least two or more inkjet heads 12 other than five inkjet heads 12 may form one head pack. The plurality of head packs may be disposed in the second direction DR2 on the head plate 14.

However, components of the inkjet apparatus 1 of the disclosure may not be limited to this and the inkjet apparatus 1 may further include additional configurations for ejecting, supplying, and controlling the ink IK.

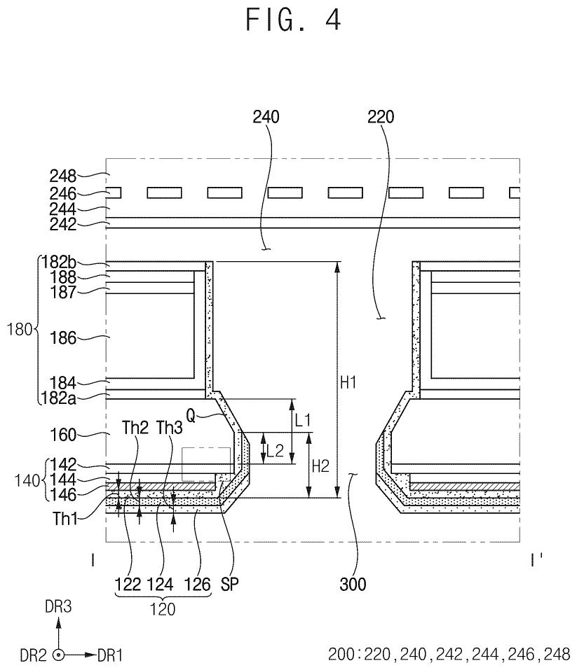

FIG. 4 is a cross-sectional view illustrating an embodiment of cross-section taken along line I-I′ in FIG. 3.

Referring to FIG. 4, the inkjet head (e.g., the inkjet head 12 in FIG. 1) may include a nozzle plate 160, a nozzle 300, a piezoelectric plate 180, a protective layer 140, a coating layer 120, and an ink channel 200.

The coating layer 120 may include a composite coating layer 122, an inorganic coating layer 124, and a liquid-repellent coating layer 126. The protective layer 140 may include a first protective layer 142, a second protective layer 144, and a third protective layer 146. The piezoelectric plate 180 may include a first polymer layer 182a, an organic layer 184, a piezoelectric member 186, a metal layer 187, a glass layer 188, and a second polymer layer 182b.

The inkjet head may include the nozzle plate 160. The nozzle plate 160 may be disposed inside the inkjet head. In addition, the nozzle plate 160 may define the nozzle 300 through which the ink (e.g., the ink IK in FIG. 1) is ejected. In an embodiment, the nozzle 300 may be defined in an area where one end of a side surface of the nozzle plate 160 connected to the a rear surface of the nozzle plate 160 is disposed, for example.

The nozzle plate 160 may be disposed adjacent to the nozzle 300. The ink may pass through the nozzle 300 adjacent to the nozzle plate 160. Specifically, the ink supplied from the ink channel 200 disposed inside the inkjet head may be supplied to the nozzle 300. Accordingly, the ink supplied from the control part (e.g., the control part 30 in FIG. 3) may be ejected to the outside through the nozzle 300.

The nozzle plates 160 may be separated from each other in the first direction DR1 with the nozzle 300 as the center in a cross-sectional view, but may have a shape surrounding a hole which is the nozzle 300 in the plane defined by the first and second direction DR1 and DR2. In an embodiment, the nozzle 300 may be a through hole that penetrates the nozzle plate 160 in the third direction DR3 and may be surrounded by the nozzle plate 160, for example. That is, the nozzle plates 160 may be connected to each other in the plane.

The inkjet head may include at least one of the nozzle 300. The nozzle 300 may be exposed from a rear surface of the inkjet head. The nozzle 300 may directly eject the ink (e.g., the ink IK in FIG. 3). The nozzle 300 may receive the ink from the ink channel 200 disposed inside the inkjet head. In an embodiment, a diameter of the nozzle may be about 1000 nanometers (nm) or more and about 10000 nm or less.

In an embodiment, the nozzle plate 160 may be symmetrical in a cross-sectional view with respect to an imaginary line that passes through the center of the nozzle 300 and is parallel to the third direction DR3. In an alternative embodiment, the nozzle plate 160 may be asymmetric in a cross-sectional view with respect to the imaginary line. In addition, the nozzle plate 160 may include an inclined portion Q having an inclined surface inclined in a direction away from the nozzle 300.

The piezoelectric plate 180 may be disposed on an upper portion of the nozzle plate 160. The first polymer layer 182a may be disposed on the nozzle plate 160. In an embodiment, the first polymer layer 182a may include an adhesive material. In an embodiment, the adhesive material may include an epoxy, a silicone-based polymer bonding agent, or the like, for example. These may be used in alone or in any combinations with each other.

The organic layer 184 may be disposed on the first polymer layer 182a. The organic layer 184 and the nozzle plate 160 may be combined through the first polymer layer 182a. In an embodiment, the organic layer 184 may include a parylene. The organic layer 184 may cover a rear surface and a side surface of the piezoelectric member 186. Accordingly, the organic layer 184 may reduce a damage occurring to the piezoelectric member 186.

The piezoelectric member 186 may contact the organic layer 184. The piezoelectric member 186 may control a flow of the ink supplied to the nozzle 300 during an ink ejection process. Specifically, an electrical signal generated from the ink control part 30 may be applied to the piezoelectric plate 180 to generate a vibration. A pressure may be generated within the inkjet head from the vibration, thereby a flow rate of the ink may be controlled.

The piezoelectric member 186 may adjust a pressure outside and inside the inkjet head. In an embodiment, the piezoelectric member 186 may adjust an external pressure and a pressure of a first ink chamber 240 of the ink channel 200 to be the same as or different from each other, for example. In an embodiment, the piezoelectric member 186 may adjust the pressure of the first ink chamber 240 to be higher than the external pressure. Accordingly, the ink in the first ink chamber 240 may be ejected to an outside of the inkjet head.

In another embodiment, the piezoelectric member 186 may adjust the external pressure and the pressure of the first ink chamber 240 to be equal. Accordingly, the ink in the first ink chamber 240 may not be ejected to the outside of the inkjet head.

In an embodiment, the piezoelectric member 186 may include a piezoelectric material. In an embodiment, the piezoelectric material may include a lead zirconate titanate (“PZT”), for example.

The metal layer 187 may be disposed on the piezoelectric member 186. In an embodiment, a rear surface of the metal layer 187 may contact an upper surface of the piezoelectric member 186, for example. A side surface of the metal layer 187 may contact a portion of the organic layer 184. The metal layer 187 may protect an upper portion of the piezoelectric member 186. In an embodiment, the metal layer 187 may include a conductive metal. In an embodiment, the conductive metal may include an aluminum (Al), for example. However, the disclosure may not be limited to this.

The glass layer 188 may be disposed on the metal layer 187. In an embodiment, a rear surface of the glass layer 188 may contact an upper surface of the metal layer 187, for example. A side surface of the glass layer 188 may contact a portion of the organic layer 184.

The second polymer layer 182b may be disposed on the glass layer 188. In an embodiment, a portion of a rear surface of the second polymer layer 182b may contact the upper surface of the glass layer 188, for example. A remaining portion of the rear surface of the second polymer layer 182b may contact a portion of the organic layer 184. The second polymer layer 182b may be substantially equal in material and function to the first polymer layer 182a.

The protective layer 140 may be disposed under the nozzle plate 160. A step SP may be defined between the nozzle plate 160 and the protective layer 140. Since the protective layer 140 may not cover a portion of the rear surface of the nozzle plate 160, the step SP having a step shape in a cross-sectional view may be generated. Specifically, during a performing process to define a hole (e.g., laser hole) in the nozzle plate 160 and the protective layer 140, a damage may be generated in at least a portion of the protective layer 140, thereby generating the step SP having the step shape.

The first protective layer 142 may be disposed under the nozzle plate 160. In an embodiment, the first protective layer 142 may contact the nozzle plate 160. Specifically, the first protective layer 142 may contact the rear surface of the nozzle plate 160, for example. In addition, the second protective layer 144 may be disposed under the first protective layer 142. In an embodiment, the second protective layer 144 may contact the first protective layer 142, for example. In an embodiment, the first protective layer 142 may include an organic material. In addition, in an embodiment, a thickness of the first protective layer 142 along a thickness direction may be about 30 nm or less. Here, an expression such as “a thickness direction” of a layer may mean a direction perpendicular to a main plane extension direction of the layer. Preferably, the thickness of the first protective layer 142 along the thickness direction may be about 15 nm or more and about 100 nm or less. However, the disclosure may not be limited to this.

In an embodiment, the second protective layer 144 may include an inorganic material. In an embodiment, the inorganic material may include silicon (Si), oxygen (O), carbon (C), or the like, for example. These may be used in alone or in any combinations with each other. In addition, in an embodiment, a thickness of the second protective layer 144 along the thickness direction may be about 25 nm or less. Preferably, the second protective layer 144 may have a thickness of about 5 nm or more and about 100 nm or less along the thickness direction.

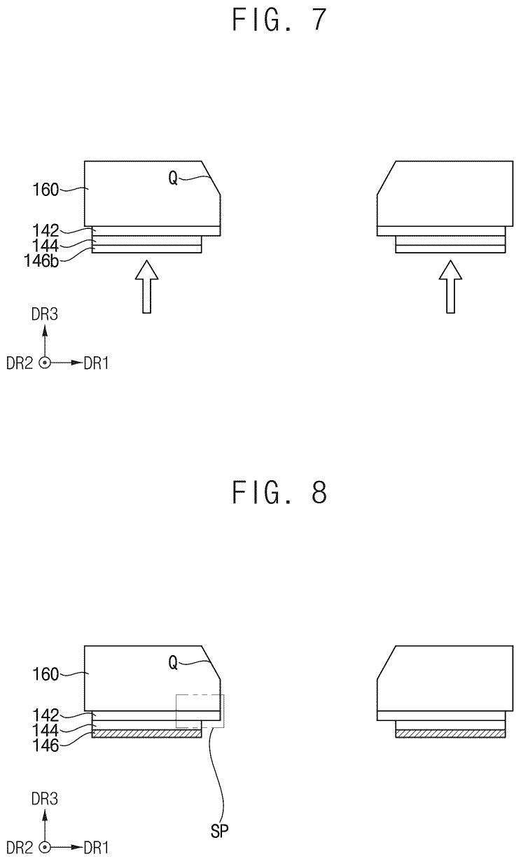

The third protective layer 146 may be disposed under the second protective layer 144. In an embodiment, the third protective layer 146 may contact the second protective layer 144, for example. A rear surface of the third protective layer 146 may contact the composite coating layer 122. In order for the third protective layer 146 to be combined with the composite coating layer 122, an etching or a surface modification process may be performed on the third protective layer 146. Accordingly, at least a portion of a fluorine (F) on the rear surface of the third protective layer 146 may be removed. In an embodiment, all fluorine (F) on the rear surface of the third protective layer 146 may be removed, for example. This will be explained later with reference to FIGS. 7 and 8.

In an embodiment, a thickness of the third protective layer 146 along the thickness direction may be about 20 nm or less. In addition, in an embodiment, the third protective layer 146 may include a carbon (C), an oxygen (O), a fluorine (F), or the like. These may be used in alone or in any combinations with each other.

An end of the first protective layer 142 facing the nozzle 300 may coincide with a end of the nozzle plate 160 facing the nozzle 300. The end of the first protective layer 142 facing the nozzle 300 may be disposed closer to the nozzle 300 than an end of the second protective layer 144 facing the nozzle 300 is to the nozzle 300. The end of the first protective layer 142 facing the nozzle 300 may be disposed closer to the nozzle 300 than an end of the third protective layer 146 facing the nozzle 300 is to the nozzle 300. That is, a length of the first protective layer 142 in the first direction DR1 may be relatively larger than a length of each of the second protective layer 144 and the third protective layer 146 in the first direction DR1. However, the disclosure may not be limited to this.

The coating layer 120 may be disposed under the protective layer 140. The coating layer 120 may be disposed on the rear and side surfaces of the nozzle plate 160. In an embodiment, the coating layer 120 may cover at least a portion of each of the rear surface and the side surface of the nozzle plate 160, for example.

In an embodiment, each of the composite coating layer 122, the inorganic coating layer 124, and the liquid-repellent coating layer 126 may have different thicknesses with each other along the thickness direction. In addition, in an embodiment, the composite coating layer 122, the inorganic coating layer 124, and the liquid-repellent coating layer 126 may each include different materials from each other.

The composite coating layer 122 may be disposed on the side surface of the nozzle plate 160 and a side surface of the protective layer 140. In addition, the composite coating layer 122 may be further disposed on a rear surface of the protective layer 140 and a side surface of the piezoelectric plate 180. In an embodiment, the composite coating layer 122 may cover the side surface of the nozzle plate 160, the side surface and rear surface of the protective layer 140, and the side surface of the piezoelectric plate 180, for example.

The composite coating layer 122 may cover at least a portion of the side surface of the piezoelectric plate 180. In an embodiment, the composite coating layer 122 may extend from a lower portion of the protective layer 140 to a height H1 where an upper surface of the piezoelectric plate 180 is disposed. Specifically, the composite coating layer 122 may cover each of the rear surface of the protective layer 140 and the side surface of the piezoelectric plate 180 from a lower portion of the third protective layer 146 to the height H1 where the second polymer layer 182b is disposed.

In an embodiment, a thickness Th1 of the composite coating layer 122 may be about 500 nm or less along the thickness direction. Preferably, the thickness Th1 of the composite coating layer 122 may be about 20 nm or more and about 100 nm or less along the thickness direction. However, the disclosure may not be limited to this.

In an embodiment, the composite coating layer 122 may include an organic material, an inorganic material, a metal material, or the like. These may be used in alone or in any combinations with each other. In an embodiment, the metal material may include an aluminum (Al), for example. The organic material may include a carbon (C), an oxygen (O), a hydrogen (H), or the like. The inorganic material may include a metal oxide, a silicon tin oxide (SiSnOx), or the like. These may be used in alone or in any combinations with each other. In this specification, the composite coating layer 122 may be also referred to as a first coating layer.

The inorganic coating layer 124 may be disposed under the composite coating layer 122. In an embodiment, the inorganic coating layer 124 may cover at least a portion of the composite coating layer 122, for example. The inorganic coating layer 124 may cover the composite coating layer 122 to a height disposed immediately under the inclined portion Q of the nozzle plate 160. In an embodiment, the inorganic coating layer 124 may extend from a lower portion of the composite coating layer 122 to a height H2 where the side surface of the nozzle plate 160 disposed under the inclined portion Q is disposed, for example. However, the disclosure may not be limited to this.

In an embodiment, a length L1 of a portion of the composite coating layer 122 overlapping the side surface of the nozzle plate 160 is greater than a length L2 of a portion of the inorganic coating layer 124 overlapping the side surface of the nozzle plate 160. Specifically, the length L1 in the third direction DR3 in which the composite coating layer 122 extends along the side surface of the nozzle plate 160 is greater than the length L2 in which the inorganic coating layer 124 extends along the side surface of the composite coating layer 122. In an embodiment, a thickness Th2 of the inorganic coating layer 124 along the thickness direction may be about 1000 nm or less. Preferably, the thickness Th2 of the inorganic coating layer 124 along the thickness direction may be about 5 nm or more and about 400 nm or less. However, a shortest distance between nozzle plates 160 adjacent to each other in the first direction DR1 may be about 1000 nm. Accordingly, when the shortest distance exceeds the above-described range, ink ejection characteristics from the nozzle 300 may deteriorate.

In an embodiment, the inorganic coating layer 124 may include an inorganic material. The inorganic material may include a silicon oxide (SiOx), a silicon nitride (SiNx), an aluminum oxide (Al2O3), a silicon nitride oxide (SiNxOy), or the like. These may be used in alone or in any combinations with each other. In addition, the inorganic coating layer 124 may have a substantially uniform thickness along the profile of the composite coating layer 122. In this specification, the inorganic coating layer 124 may be also referred to as a second coating layer.

The liquid-repellent coating layer 126 may be disposed under the inorganic coating layer 124. The liquid-repellent coating layer 126 may overlap at least a portion of the inorganic coating layer 124. In an embodiment, the liquid-repellent coating layer 126 may contact a rear surface of the inorganic coating layer 124, for example.

The liquid-repellent coating layer 126 may be disposed only on the lower portion of the nozzle plate 160. In an embodiment, the liquid-repellent coating layer 126 may extend from a lower portion of the inorganic coating layer 124 to a height where the protective layer 140 is disposed. Specifically, the section where the liquid-repellent coating layer 126 is maximally extended in the third direction DR3 along a side surface of the inorganic coating layer 124 may be a portion of the inorganic coating layer 124 overlapping the rear surface of the third protective layer 146. However, the liquid-repellent coating layer 126 may not extend in the third direction DR3 to a height where each of the composite coating layer 122 and the inorganic coating layer 124 covers the nozzle plate 160.

The liquid-repellent coating layer 126 may be disposed adjacent to the nozzle 300 through which the ink is ejected. That is, the liquid-repellent coating layer 126 may not extend along the side surface of the nozzle plate 160 to an inside of the inkjet head.

In an embodiment, a thickness Th3 of the liquid-repellent coating layer 126 along the thickness direction may be about 2 nm or more and about 20 nm or less. Preferably, the thickness Th3 of the liquid-repellent coating layer 126 along the thickness direction may be about 2 nm or more and about 15 nm or less. However, the disclosure may not be limited to this.

In an embodiment, the liquid-repellent coating layer 126 may include a hydrophobic material. The hydrophobic material may have a water contact angle of about 100 degrees or more and about 200 degrees or less. The hydrophobic material may include a linear or branched alkyl chain and a ring structure bonded thereto. The alkyl chain may include —CF, —CF2, —CF3, O, H, Si, or the like. These may be used in alone or in any combinations with each other.

That is, the inkjet head illustrated in FIG. 4 may include a triple coating layer including the composite coating layer 122, the inorganic coating layer 124, and the liquid-repellent coating layer 126.

Hereinafter, effects of the disclosure will be described in detail. The existing inkjet head does not include a coating layer 120 that covers the step SP defined by the nozzle plate 160 and the protective layer 140. Accordingly, a frictional force may be concentrated on the step SP due to a repeated ink ejection and a blotting process. Accordingly, the protective layer 140 may be damaged and the ink ejection characteristics may deteriorate.

As the inkjet head according to the disclosure may include a coating layer 120 covering the step SP, the step SP may be compensated by sequentially covering the nozzle plate 160 and the protective layer 140 disposed at the step SP with the composite coating layer 122 and the inorganic coating layer, and the liquid-repellent coating layer 126. Accordingly, when a scratch is generated in the protective layer 140 that covers the rear surface of the nozzle plate 160, a frictional force may be prevented from being concentrated on a portion where a portion of the rear surface of the nozzle plate 160 is exposed. Accordingly, a deterioration of the ink ejection characteristics may be reduced and a durability of the inkjet head may be improved.

The ink channel 200 may adjust the flow rate of the ink in order to eject the ink to the outside of the inkjet head. The ink channel 200 may include an ink supply passage 220, the first ink chamber 240, a metal plate 242, a second ink chamber 244, a metal mesh 246, and a third ink chamber 248.

The ink supply passage 220 may be connected to the nozzle 300 in the third direction DR3. In addition, the ink supply passage 220 may be connected to the first ink chamber 240 storing the ink in the third direction DR3.

The ink supply passage 220 may be defined by the piezoelectric plate 180. The ink supply passage 220 may be disposed adjacent to the piezoelectric plate 180. In an embodiment, the ink supply passage 220 may be surrounded by a piezoelectric plate 180, for example. In addition, the ink supply passage 220 may be a through hole penetrating the piezoelectric plate 180 in the third direction DR3.

The ink supply passage 220 may receive the ink from the first ink chamber 240. The ink supply passage 220 may be a passage through which the ink passes when the ink is ejected from the first ink chamber 240. In addition, the ink supply passage 220 may deliver the ink to the nozzle 300 and eject the ink toward the outside of the inkjet head. Specifically, the ink may pass through the ink supply passage 220 in a direction opposite to the third direction DR3 and be ejected from the nozzle 300 toward the outside.

In addition, the ink supply passage 220 may be disposed adjacent to a portion of the composite coating layer 122. In an embodiment, the ink supply passage 220 may be disposed adjacent to a portion of the composite coating layer 122 that covers at least a portion of the side surface of the piezoelectric plate 180, for example.

The ink may be stored in the first ink chamber 240. Additionally, the first ink chamber 240 may deliver the ink to the ink supply passage 220. As described above, when a pressure outside the inkjet head and a pressure in the first ink chamber 240 are equal to each other, the ink may be stored in the first ink chamber 240. That is, in a case that a pressure outside the inkjet head and a pressure in the first ink chamber 240 are equal to each other, the ink may not be ejected from the first ink chamber 240 toward the outside.

The metal plate 242 may be placed on the first ink chamber 240. The metal plate 242 may include a metal material. The metal material may include a steel use stainless (“SUS”).

The second ink chamber 244 may be disposed on the metal plate 242. The ink may be stored in the second ink chamber 244. In addition, the second ink chamber 244 may deliver the ink to the first ink chamber 240.

The metal mesh 246 may be disposed on the second ink chamber 244. The metal mesh 246 may include a metal material. The metal material may include an SUS.

The third ink chamber 248 may be disposed on the metal mesh 246. The ink may be stored in the third ink chamber 248. In addition, the third ink chamber 248 may deliver the ink to the second ink chamber 244. The first, second, and third ink chambers 240, 244, and 248 may be connected through a connection passage. That is, the ink may sequentially pass from the third ink chamber 248 to the second ink chamber 244 and the first ink chamber 240 through the connection passage, and be delivered to the ink supply passage 220.

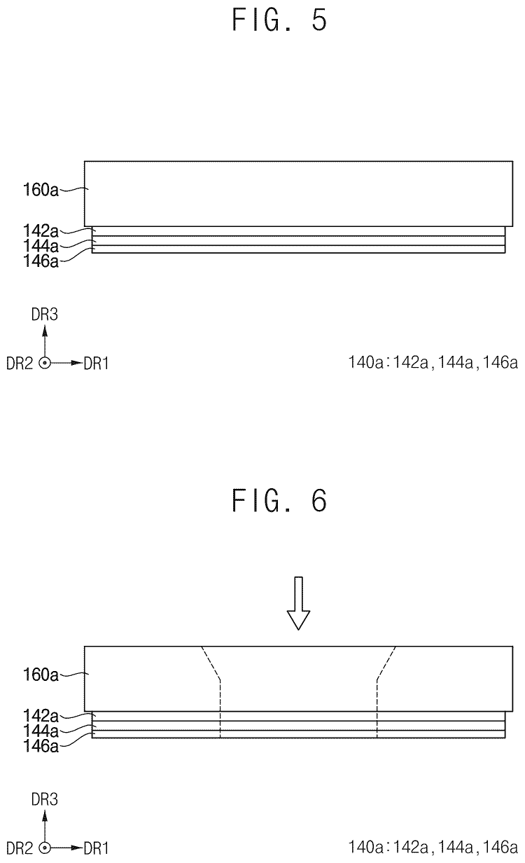

FIGS. 5, 6, 7, 8, 9, 10, and 11 are cross-sectional views illustrating a method of manufacturing the inkjet head of FIG. 3.

Hereinafter, content that overlaps with the components of the inkjet head described with reference to FIG. 4 will be omitted or simplified.

Referring to FIG. 5, a preliminary protective layer 140a may be formed on the preliminary nozzle plate 160a. In an embodiment, the preliminary protective layer 140a may be formed on one surface of the preliminary nozzle plate 160a in that order, including the first preliminary protective layer 142a, the second preliminary protective layer 144a, and the third preliminary protective layer 146a, for example. A length and a thickness of the preliminary protective layer 140a in a cross-sectional view may be smaller than a length and a thickness of the preliminary nozzle plate 160a in a cross-sectional view. However, the disclosure may not be limited to this. In this specification, the preliminary nozzle plate 160a may be also referred to as a substrate.

Referring to FIG. 6, a portion of the preliminary nozzle plate 160a may be removed by irradiating an intense light (e.g., laser) to the preliminary nozzle plate 160a. In an embodiment, a portion of the preliminary nozzle plate 160a may be removed along the dotted line, for example. Accordingly, a through hole penetrating the preliminary nozzle plate 160a in a thickness direction may be defined. The laser may be irradiated on another surface of the preliminary nozzle plate 160a to which the preliminary protective layer 140a is not attached. The portion of the preliminary nozzle plate 160a adjacent to the through hole caused by the laser may have a shape such as a step or a shape protruding toward the through hole in a cross-sectional view.

In addition, the laser may penetrate the preliminary nozzle plate 160a and also penetrate a portion of the preliminary protective layer 140a in a thickness direction. Parts of each of the first preliminary protective layer 142a, the second preliminary protective layer 144a, and the third preliminary protective layer 146a that overlap the through hole may be removed.

Referring to FIG. 7, the nozzle plate 160 in which the through hole is defined may be formed from the preliminary nozzle plate 160a by the laser irradiation. In addition, by the laser irradiation, each of the first preliminary protective layer 142a and the second preliminary protective layer 144a may be formed into a second protective layer 144 and a third protective layer 146. By the laser irradiation, the third preliminary protective layer 146a may be formed as the third protective layer 146b before a surface modification process.

A portion of a rear surface of the third protective layer 146b may be removed. In an embodiment, a portion of the rear surface of the third protective layer 146b may be etched or surface modified, for example. Accordingly, an amount of fluorine (F) remained on the rear surface of the third protective layer 146b may be reduced. Accordingly, an adhesive force with a material attached to the rear surface of the third protective layer 146b may be increased. The material may be the composite coating layer (e.g., the composite coating layer 122 in FIG. 4) or the inorganic coating layer (e.g., the inorganic coating layer 124 in FIG. 4).

Referring to FIG. 8, a portion of the third protective layer 146b may be removed to form the third protective layer 146. Accordingly, fluorine (F) may not exist on the rear surface of the third protective layer 146. However, the disclosure may not be limited to this.

A width of the through hole penetrating the nozzle plate 160 may be narrower than a width of the through hole penetrating the protective layer 140. Accordingly, the step SP may be defined between the nozzle plate 160 and the protective layer 140.

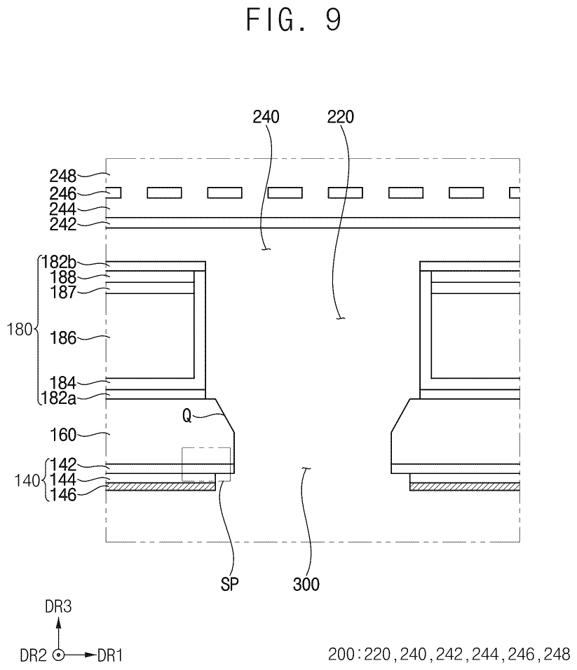

Referring to FIG. 9, the piezoelectric plate 180, the first ink chamber 240, the metal plate 242, the second ink chamber 244, the metal mesh 246, and the third ink chamber 248 may be formed on the nozzle plate 160 sequentially. Through holes defined in the nozzle plate 160 and the protective layer 140 may be nozzles 300 through which the ink is ejected. In addition, as the piezoelectric plate 180 is formed, the ink supply passage 220 adjacent to the piezoelectric plate 180 may be defined.

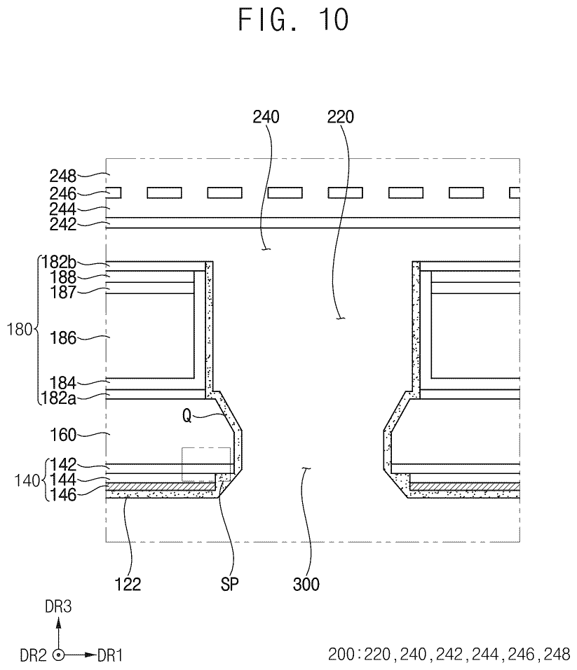

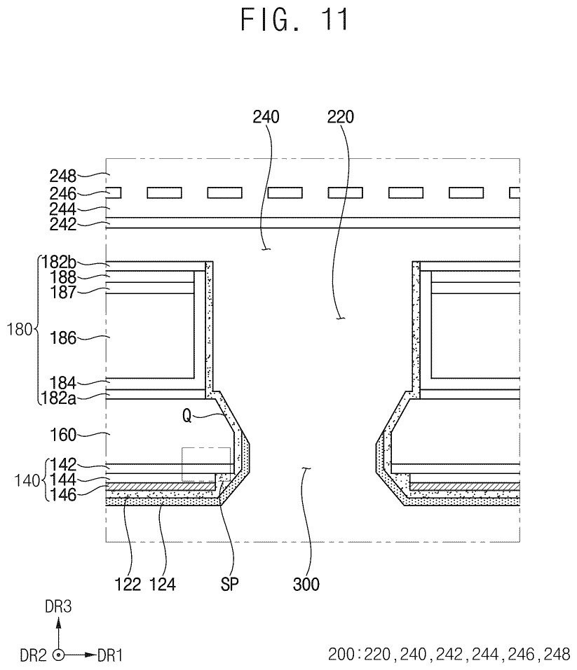

Referring to FIG. 10, the composite coating layer 122 may be formed covering the protective layer 140, a portion of the rear surface of the nozzle plate 160, the side surface of the nozzle plate 160, and the side surface of the piezoelectric plate 180. The composite coating layer 122 may be deposited on the rear surface of the nozzle plate 160 and side surface of the nozzle plate 160 and the sides of the piezoelectric plate 180 by an atomic layer deposition (“ALD”) process. The composite coating layer 122 may cover all side surface of the piezoelectric plate 180. The composite coating layer 122 may cover the step SP.

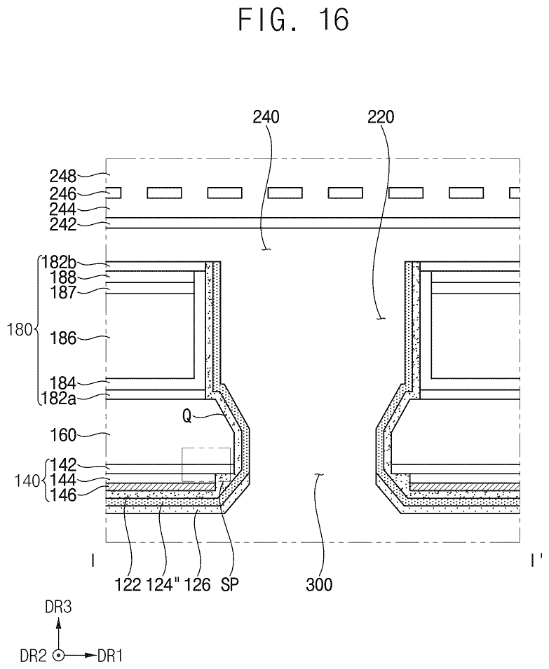

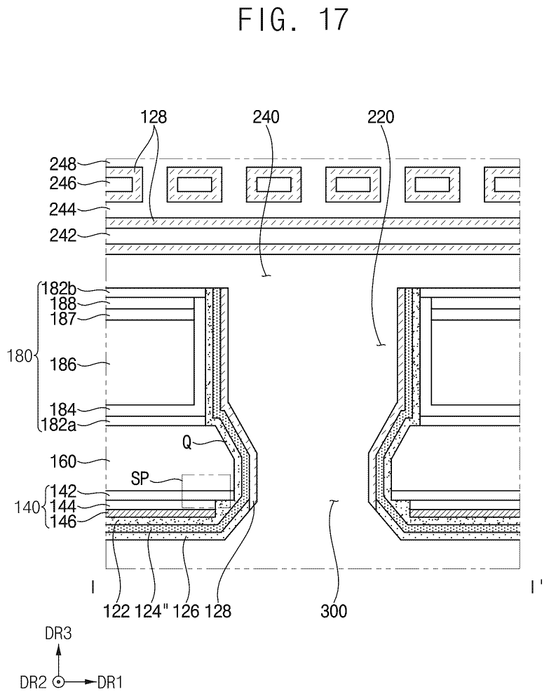

Referring to FIG. 11, the inorganic coating layer 124 may be formed on a portion of the composite coating layer 122. The inorganic coating layer 124 may cover at least a portion of the side surface of the composite coating layer 122. The inorganic coating layer 124 may be deposited on one surface of the composite coating layer 122 by a chemical vapor deposition (“CVD”), or an ALD, or a physical vapor deposition (“PVD”) process. The inorganic coating layer 124 may extend to a height where the side surface of the nozzle plate 160 is disposed under the inclined portion Q of the nozzle plate 160. However, the disclosure may not be limited to this, and the inorganic coating layer 124 may extend to a height that overlaps at least a portion of the ink supply passage 220. This will be explained later with reference to FIGS. 16 and 17.

The liquid-repellent coating layer (e.g., the liquid-repellent coating layer 126 in FIG. 4) may be formed on a portion of the inorganic coating layer 124. The liquid-repellent coating layer 126 is formed on the rear surface of the inorganic coating layer 124 by a PVD process. Accordingly, the inkjet head in FIG. 1 may be manufactured.

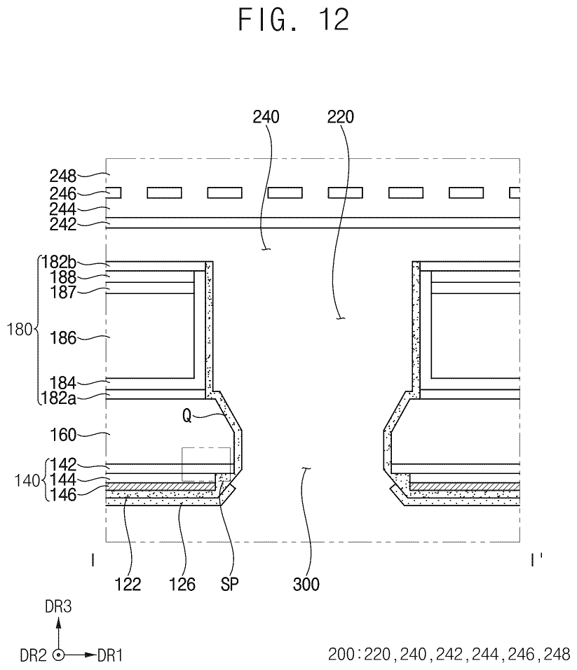

FIG. 12 is a cross-sectional view illustrating another embodiment of cross-section taken along line I-I′ in FIG. 3. The inkjet head in FIG. 12 may substantially equal to the inkjet head in FIG. 4 except for the inorganic coating layer. Hereinafter, content that overlaps with the content described with reference to FIG. 4 will be omitted or simplified.

Referring to FIG. 12, the composite coating layer 122 may cover the protective layer 140, a portion of the rear surface of the nozzle plate 160, and the side surface of the nozzle plate 160. The liquid-repellent coating layer 126 may be disposed on the composite coating layer 122. The liquid-repellent coating layer 126 may be disposed on a surface of the inkjet head adjacent to the surface from which the ink is ejected from the nozzle 300. In an embodiment, the liquid-repellent coating layer 126 may be formed on a rear surface of the composite coating layer 122, for example. That is, the liquid-repellent coating layer 126 may not extend to a height where a side surface of the composite coating layer 122 is disposed. However, the disclosure may not be limited to this.

The inkjet head in FIG. 12 may include a double coating layer including the composite coating layer 122 and the liquid-repellent coating layer 126.

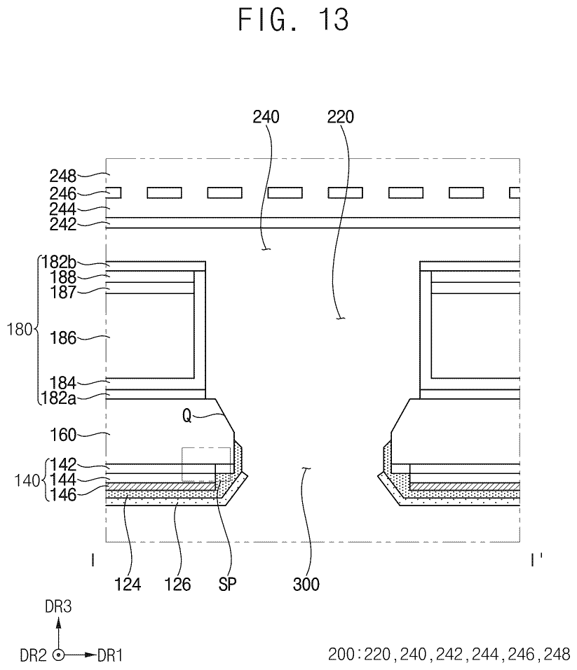

FIG. 13 is a cross-sectional view illustrating another embodiment of cross-section taken along line I-I′ in FIG. 3. The inkjet head in FIG. 13 is substantially equal to the inkjet head in FIG. 4 except for the composite coating layer. Hereinafter, content that overlaps with the content described with reference to FIG. 4 will be omitted or simplified.

Referring to FIG. 13, the inorganic coating layer 124 may cover the protective layer 140, a portion of the rear surface of the nozzle plate 160, and at least a portion of the side surface of the nozzle plate 160. In an embodiment, the inorganic coating layer 124 may extend to a height where the side of the nozzle plate 160 disposed under the inclined portion Q is disposed, for example.

The liquid-repellent coating layer 126 may be disposed on the back of the inorganic coating layer 124. A liquid-repellent coating layer 126 may be disposed on a surface of the inkjet head. In an embodiment, the liquid-repellent coating layer 126 may be formed on the rear surface of the inorganic coating layer 124. That is, the liquid-repellent coating layer 126 may not extend to a height where the side surface of the inorganic coating layer 124 is disposed, for example. However, the disclosure may not be limited to this.

The inkjet head in FIG. 13 may include a double coating layer including an inorganic coating layer (or a composite coating layer) 124 and a liquid-repellent coating layer 126.

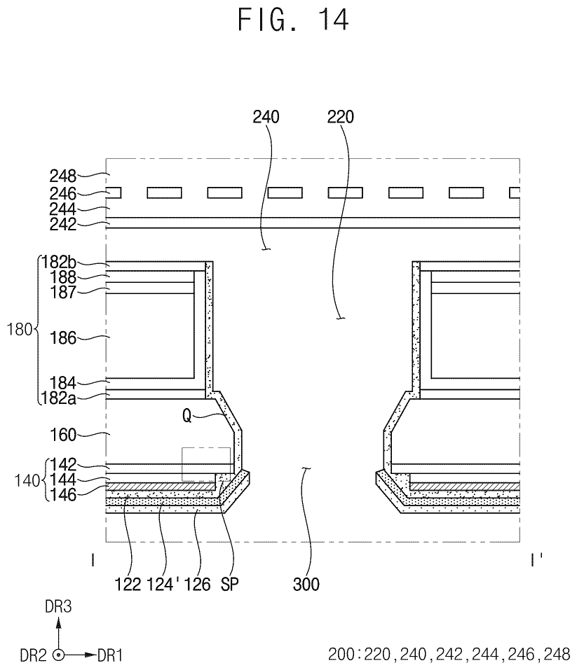

FIG. 14 is a cross-sectional view illustrating another embodiment of cross-section taken along line I-I′ in FIG. 3. The inkjet head in FIG. 13 is substantially equal to the inkjet head in FIG. 4 except for the inorganic coating layer. Hereinafter, content that overlaps with the content described with reference to FIG. 4 will be omitted or simplified.

Referring to FIG. 14, an adhesive coating layer 124′ may be disposed under the composite coating layer 122. In an embodiment, the adhesive coating layer 124′ may contact the rear surface of the composite coating layer 122, for example. The adhesive coating layer 124′ may be deposited on a rear surface of the composite coating layer 122 by a PVD process. In this specification, the adhesive coating layer 124′ may be also referred to as a second coating layer.

The adhesive coating layer 124′ may be disposed on a surface of the inkjet head such as the liquid-repellent coating layer 126. That is, the adhesive coating layer 124′ may not extend to a height where the side surface of the composite coating layer 122 is disposed. However, the disclosure may not be limited to this.

The adhesive coating layer 124′ may be disposed between the composite coating layer 122 and the liquid-repellent coating layer 126. The adhesive coating layer 124′ may combine the composite coating layer 122 and the liquid-repellent coating layer 126 with each other. In an embodiment, the adhesive coating layer 124′ may serve as a covalent bond between the composite coating layer and the liquid-repellent coating layer 126, for example. Additionally, the adhesive coating layer 124′ may serve as a buffer between the composite coating layer and the liquid-repellent coating layer 126.

In an embodiment, the adhesive coating layer 124′ may include a silicon and a polymer compound. In an embodiment, the polymer compound may include an amide group, an epoxy group, an amine group, or the like, for example. These may be used in alone or in any combinations with each other.

In an embodiment, a thickness of the adhesive coating layer 124′ along the thickness direction may be about 100 nm or less. Preferably, a thickness of the adhesive coating layer 124′ along the thickness direction may be about 5 or more and about 20 nm or less.

As described above, the adhesive coating layer 124′ may improve a bonding force between the composite coating layer 122 and the liquid-repellent coating layer 126 and may serve as the buffer. Accordingly, a density of the liquid-repellent coating layer 126 may increase, and the durability of the inkjet head may be further improved.

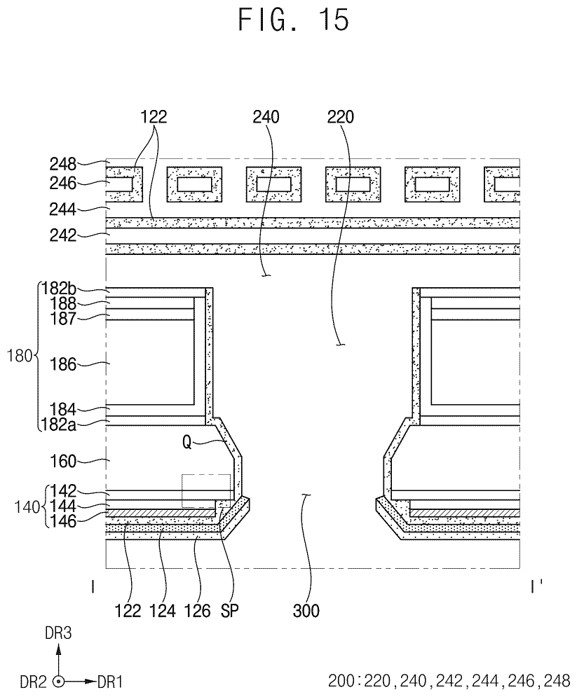

The inkjet head in FIG. 14 may include a triple coating layer including the composite coating layer 122, the adhesive coating layer 124′, and the liquid-repellent coating layer 126. FIG. 15 is a cross-sectional view illustrating another embodiment of cross-section taken along line I-I′ in FIG. 3.

The inkjet head in FIG. 15 is substantially equal to the inkjet head in FIG. 4 except for the composite coating layer. Hereinafter, content that overlaps with the content described with reference to FIG. 4 will be omitted or simplified.

Referring to FIG. 15, the composite coating layer 122 may cover the first, second, and third ink chambers 242, 244, and 248. In an embodiment, the composite coating layer 122 may cover each of the metal plate 242 and the metal mesh 246, for example. Specifically, the composite coating layer 122 may surround both upper and rear surfaces of the metal plate 242. In addition, the composite coating layer 122 may surround upper, lower, and side surfaces of the metal mesh 246.

FIG. 16 is a cross-sectional view illustrating another embodiment of cross-section taken along line I-I′ in FIG. 3.

The inkjet head in FIG. 16 is substantially equal to the inkjet head in FIG. 4 except for the inorganic coating layer. Hereinafter, content that overlaps with the content described with reference to FIG. 4 will be omitted or simplified.

Referring to FIG. 16, an inorganic coating layer 124″ may overlap the side of the piezoelectric plate 180. Specifically, the inorganic coating layer 124″ will extend from the rear surface of the composite coating layer 122 through the height H2 which is disposed under the inclined portion Q of the nozzle plate 160 to a height where the side surface of the piezoelectric plate 180 is disposed. That is, the inorganic coating layer 124″ may extend from the rear surface of the composite coating layer 122 to the height H1 (refer to FIG. 4) where the upper surface of the piezoelectric plate 180 is disposed.

FIG. 17 is a cross-sectional view illustrating another embodiment of cross-section taken along line I-I′ in FIG. 3.

The inkjet head in FIG. 17 is substantially equal to the inkjet head in FIG. 16 except for an internal coating layer. Hereinafter, content that overlaps with the content described with reference to FIG. 4 will be omitted or simplified.

Referring to FIG. 17, an internal coating layer 128 may be disposed on the inorganic coating layer 124″. One end of the internal coating layer 128 may contact the end of the liquid-repellent coating layer (also referred to as a liquid-repellent layer) 126 facing the nozzle 300. However, the disclosure may not be limited to this. In this specification, the internal coating layer may be also referred to as a third coating layer.

The internal coating layer 128 may overlap a portion of the nozzle plate 160 and at least a portion of the piezoelectric plate 180. The internal coating layer 128 may extend on the inorganic coating layer 124″ to a height H1 where the upper surface of the piezoelectric plate 180 is disposed.

The internal coating layer 128 may cover the first, second, and third ink chambers 242, 244, and 248. The internal coating layer 128 may cover each of the metal plate 242 and the metal mesh 246. Specifically, the internal coating layer 128 may surround both the upper and rear surfaces of the metal plate 242. In addition, the internal coating layer 128 may surround the upper, rear, and side surfaces of the metal mesh 246.

In an embodiment, a thickness of the internal coating layer 128 along the thickness direction may be about 2 nm or more and about 20 nm or less. Preferably, the thickness of the internal coating layer 128 along the thickness direction may be about 2 nm or more and about 15 nm or less. However, the disclosure may not be limited to this.

In an embodiment, a thickness of the internal coating layer 128 along the thickness direction may be substantially equal to a thickness of the liquid-repellent coating layer 126 along the thickness direction. However, the disclosure may not be limited to this.

In an embodiment, the internal coating layer 128 may include a hydrophilic material or a hydrophobic material. In an embodiment, the internal coating layer 128 may include a carbon (C), a hydrogen (H), an oxygen (O), a silicon (Si), a fluorine (F), a nitrogen (N), or the like. These may be used in alone or in any combinations with each other.

The inkjet head and the method of manufacturing the same in the embodiments may be applied to manufacture a display device included in a computer, a notebook, a mobile phone, a smartphone, a smart pad, a portable media player (“PMP”), a personal digital assistance (“PDA”), a motion pictures expert group audio layer III (“MP3”) player, or the like.

Although the inkjet head and the method of manufacturing the same in the embodiments have been described with reference to the drawings, the illustrated embodiments are examples, and may be modified and changed by a person having ordinary knowledge in the relevant technical field without departing from the technical spirit described in the following claims.

What is claimed is:

1. An inkjet head comprising:
a nozzle which ejects ink;
a nozzle plate adjacent to the nozzle and defining the nozzle, the nozzle plate including:
a side surface;
a protective layer disposed under the nozzle plate, the protective layer including:
a side surface;
a first coating layer disposed on the side surface of the nozzle plate and the side surface of the protective layer, the first coating layer including:
a rear surface; and
a side surface; and
a liquid-repellent layer disposed on the rear surface of the first coating layer and the side surface of the first coating layer,
wherein the first coating layer covers a step defined between the nozzle plate and the protective layer.

2. The inkjet head of claim 1, further comprising:
a piezoelectric plate disposed on the nozzle plate,
wherein the first coating layer extends from a lower portion of the protective layer to a height where an upper surface of the piezoelectric plate is disposed.

3. The inkjet head of claim 2, further comprising:
a second coating layer disposed between the first coating layer and the liquid-repellent layer, and contacting the liquid-repellent layer.

4. The inkjet head of claim 3, wherein the nozzle plate includes an inclined portion having an inclined surface inclined in a direction away from the nozzle, and
the second coating layer extends from a lower portion of the first coating layer to a height where the side surface of the nozzle plate disposed under the inclined portion is disposed.

5. The inkjet head of claim 3, wherein the second coating layer extends from the lower portion of the protective layer to a height where the upper surface of the piezoelectric plate is disposed.

6. The inkjet head of claim 5, further comprising:
a third coating layer covering at least a portion of side surface of the second coating layer.

7. The inkjet head of claim 6, wherein a thickness of the third coating layer along a thickness direction perpendicular to a main plane extension direction of the third coating layer is substantially equal to a thickness of the liquid-repellent layer along the thickness direction.

8. The inkjet head of claim 6, further comprising:
a metal plate disposed on the piezoelectric plate; and
a metal mesh disposed on the metal plate,
wherein the third coating layer covers each of the metal plate and the metal mesh.

9. The inkjet head of claim 3, wherein the liquid-repellent layer contacts a rear surface of the second coating layer.

10. The inkjet head of claim 1, wherein the first coating layer includes an organic material, an inorganic material, and a metal material.

11. The inkjet head of claim 3, wherein the second coating layer includes an inorganic material.

12. The inkjet head of claim 3, wherein the second coating layer includes a polymer compound.

13. The inkjet head of claim 1, wherein the liquid-repellent layer includes a hydrophobic material, and
the hydrophobic material has a water contact angle which is about 100 degrees or more and about 200 degrees or less.

14. The inkjet head of claim 3, wherein a thickness of the first coating layer along a thickness direction perpendicular to a main plane extension direction of the first coating layer is about 500 nanometers or less, and
a thickness of the second coating layer along the thickness direction is about 1000 nanometers or less.

15. The inkjet head of claim 1, wherein a thickness of the liquid-repellent layer along a thickness direction perpendicular to a main plane extension direction of the liquid-repellent layer is about 20 nanometers or less.

16. The inkjet head of claim 1, wherein the liquid-repellent layer contacts the rear surface of the first coating layer.

17. A method of manufacturing an inkjet head, the method comprising:
forming a preliminary protective layer on a substrate;
forming a nozzle plate by irradiating an intense light on the substrate, the nozzle plate including a rear surface and a side surface;
forming a protective layer having a step with the nozzle plate together by irradiating the intense light on the preliminary protective layer;
forming a piezoelectric plate on the nozzle plate, the piezoelectric plate including a rear surface and a side surface;
forming a first coating layer covering each of the rear surface of the nozzle plate, the side surface of the nozzle plate, the rear surface of the piezoelectric plate, the side surface of the piezoelectric plate, and the protective layer; and
forming a liquid-repellent layer, overlapping at least a portion of the first coating layer, under the first coating layer.

18. The method of claim 17, wherein the forming the protective layer includes:
forming a first protective layer from a first preliminary protective layer contacting the rear surface of the nozzle plate;
forming a second protective layer from a second preliminary protective layer disposed under the first preliminary protective layer; and
forming a third protective layer from a third preliminary protective layer disposed under the second preliminary protective layer.

19. The method of claim 18, wherein the forming the third protective layer includes modifying a surface of the third preliminary protective layer and removing at least a portion of a fluorine (F) included in the surface of the third preliminary protective layer.

20. The method of claim 17, further comprising:
forming a second coating layer on the first coating layer; and
forming the liquid-repellent layer on a rear surface of the second coating layer.
